(19) United States
(12) Patent Application Publication
(10) Pub. No.: US 2011/0165467 A1
(43) Pub. Date: Jul. 7, 2011

(54) NEGATIVE ELECTRODE FOR RECHARGEABLE LITHIUM BATTERY AND RECHARGEABLE LITHIUM BATTERY INCLUDING THE SAME

(75) Inventors: Kyoung-Han YEW, Yongin-Si (KR); Sang-Min LEE, Yongin-Si (KR); Young-Hwan KIM, Yongin-Si (KR); Duck-Chul HWANG, Yongin-Si (KR)

(73) Assignee: SAMSUNG SDI CO., LTD.,, Yongin-Si (KR)

(21) Appl. No.: 12/881,702

(22) Filed: Sep. 14, 2010

(30) Foreign Application Priority Data
Jan. 5, 2010 (KR) 10-2010-0000546

(51) Int. Cl. H01M 4/58

(52) U.S. Cl. 429/231.8

(57) ABSTRACT

Disclosed are a negative electrode for a rechargeable lithium battery and a rechargeable lithium battery including the same. The negative electrode includes a current collector, a negative active material composition layer disposed on the surface of the current collector and including a negative active material, and an inorganic salt layer disposed on the surface of the negative active material composition layer and including an inorganic salt. The negative active material includes a silicon-based core and a carbon layer disposed on the surface of the silicon-based core. The inorganic salt includes an alkaline metal cation selected from a Na cation, a K cation, or a combination thereof; and an anion selected from a carbonate anion, a halogen anion, or a combination thereof.

### RELATED APPLICATIONS

This application claims priority to and the benefit of Korean Patent Application No. 10-2010-0000546 filed in the Korean Intellectual Property Office on Jan. 5, 2010, the entire contents of which are incorporated herein by reference.

### BACKGROUND OF THE INVENTION

1. Field of the Invention

This disclosure relates to a negative electrode for a rechargeable lithium battery and a rechargeable lithium battery including the same.

2. Description of the Related Art

Lithium rechargeable batteries have recently drawn attention as a power source for small portable electronic devices. They use an organic electrolyte solution and thereby have twice the discharge voltage of a conventional battery using an alkaline aqueous solution, and accordingly have high energy density.

For positive active materials of a rechargeable lithium battery, lithium-transition element composite oxides being capable of intercalating lithium such as LiCoO₂, LiMn₂O₄, LiNi₁₋ₓCoₓO₂ (0<x<1), and the like have been researched.

As for negative active materials of a rechargeable lithium battery, various carbon-based materials such as artificial graphite, natural graphite, and hard carbon, which can all intercalate and deintercalate lithium ions, have been used. Graphite of the carbon-based material have a low discharge potential of −0.2V, relative to lithium, and a battery using graphite as a negative active material has a high discharge potential of 3.6V and excellent energy density. Furthermore, graphite guarantees long cycle life for a battery due to its outstanding reversibility. However, a graphite active material has low density (theoretical density of 2.2 g/cc) and consequently low capacity in terms of energy density per unit volume when using the graphite as a negative active material. Further, it involves swelling or capacity reduction when a battery is misused or overcharged and the like, because graphite is likely to react with an organic electrolyte at a high discharge voltage.

In order to solve these problems, a great deal of research on oxides such as tin oxide, lithium vanadium oxides has recently been performed. However, such an oxide negative electrode does not show a sufficient battery performance and therefore there has been a great deal of further research into oxide negative materials.

### SUMMARY OF THE INVENTION

One aspect of this disclosure provides a negative electrode for a rechargeable lithium battery having improved cycle life characteristics.

Another aspect of this disclosure provides a rechargeable lithium battery including the negative electrode.

According to one aspect of this disclosure, a negative electrode for a rechargeable lithium battery is provided that includes a current collector, a negative active material composition layer disposed on the surface of the current collector and including a negative active material, and an inorganic salt layer disposed on the surface of the negative active material composition layer including an inorganic salt. The negative active material includes a silicon-based core and a carbon layer disposed on the surface of the silicon-based core. The inorganic salt includes an alkaline metal cation selected from a Na cation, a K cation, or a combination thereof; and an anion selected from a carbonate anion, a halogen anion, or a combination thereof.

The silicon-based core may include Si, SiOₓ (0<x<2), a Si—Z alloy (where Z is an element selected from the group consisting of an alkaline metal, an alkaline-earth metal, a group 13 element, a group 14 element, a transition element, a rare earth element, and a combination thereof, but not Si), or a combination thereof.

The carbon layer may include an amorphous carbon. The carbon layer may include an amorphous carbon selected from the group consisting of soft carbon, hard carbon, mesophase pitch carbide, fired coke, and mixtures thereof. One example of soft carbon would be low temperature fired carbon. The content of the carbon layer may range from about 1 part by weight to about 20 parts by weight based on 100 parts by weight of the negative active material. The thickness of the carbon layer may range from about 1 nm to about 100 nm.

The negative active material may have an average particle diameter of about 1 μm to about 20 μm.

The inorganic salt may include K₂CO₃, KCl, KF, Na₂CO₃, NaCl, NaF, or combinations thereof. The content of the inorganic salt may range from about 0.1 part by weight to about 10 parts by weight based on 100 parts by weight of the total weight of the negative active material.

Also, according to yet another aspect of this disclosure, a rechargeable lithium battery is provided that includes the negative electrode, a positive electrode including a positive active material, and a non-aqueous electrolyte.

### BRIEF DESCRIPTION OF THE DRAWING

FIG. 1 is a schematic view of a rechargeable lithium battery according to one embodiment.

### DETAILED DESCRIPTION

Exemplary embodiments will hereinafter be described in detail. However, these embodiments are exemplary, and this disclosure is not limited thereto.

The negative electrode for a rechargeable lithium battery according to one embodiment includes a current collector, a negative active material composition layer disposed on the surface of the current collector including a negative active material; and an inorganic salt layer disposed on the surface of the negative active material composition layer including an inorganic salt. The negative active material includes a silicon-based core and a carbon layer disposed on the surface of the silicon-based core.

The current collector may be selected from the group consisting of a copper foil, a nickel foil, a stainless steel foil, a titanium foil, a nickel foam, a copper foam, a polymer substrate coated with a conductive metal, and combinations thereof.

The negative active material composition layer includes a negative active material, a binder, and selectively a conductive material. Hereinafter, the constituent elements of the negative active material composition layer are described.

The negative active material includes a silicon-based core, and a carbon layer disposed on the surface of the silicon-based core.

The silicon-based core includes one selected from Si, SiOₓ (0<x<2), a Si—Z alloy (where Z is an element selected from the group consisting of an alkaline metal, an alkaline-earth metal, a group 13 element, a group 14 element, a transition element, a rare earth element, and combinations thereof, but not Si), or combinations thereof. Z is selected from the group consisting of Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, Po, and combinations thereof.

The term “core” as used herein refers to the central or interior regions of the negative active material particles as distinct from an enveloping exterior layer.

The term “silicon-based” as used herein refers to particles, or a region of particles or a material, which comprise silicon. The silicon referred to herein is silicon in any one or more of its known forms.

The surface of the silicon-based core may be coated with a carbon layer. The carbon layer may include an amorphous carbon. The amorphous carbon may be at least one selected from the group consisting of soft carbon, hard carbon, mesophase pitch carbide, fired coke, and mixtures thereof.

The amorphous carbon may be included in an amount ranging from about 1 is part by weight to about 20 parts by weight based on the total weight of the negative active material. When the content of the amorphous carbon falls in the above range, the rechargeable lithium battery including the negative active material may form a wide conduction network and maintain a conduction path between active materials having a relatively low conductivity. Thus, the electric conductivity of the rechargeable lithium battery may be improved.

The carbon layer may have a thickness ranging from about 1 nm to about 100 nm. When the carbon layer is excessively thin, the rechargeable lithium battery does not have sufficient conduction path. When the carbon layer is excessively thick, the battery capacity may be deteriorated. When the thickness of the carbon layer is within the above range, the electric conductivity of the rechargeable lithium battery including the negative active material may be improved.

The carbon layer is formed by coating the silicon-based core with amorphous carbon. The amorphous carbon may be selected from the group consisting of soft carbon (low-temperature fired carbon), hard carbon, mesophase pitch carbide, fired coke and mixtures thereof.

The coating method for the carbon layer is not particularly limited and a dry coating or a liquid coating may be used. Examples of a dry coating method include a deposition method and a chemical vapor deposition (CVD) method, and examples of a liquid coating include an impregnation method, and a spray method. When a liquid coating is used, DMSO or THF may be used as a solvent, and the concentration of carbon material in the solvent may range from about 1 wt % to about 20 wt %.

Also, the carbon layer may be formed by coating a core formed of a Si-based material with a carbon precursor and heating it in an atmosphere of an inert gas such as argon or nitrogen at a temperature of about 400° C. to about 1200° C. for about 1 hour to about 10 hours. While the heat treatment is performed, the carbon precursor is carbonized and transformed into amorphous carbon, and thus an amorphous carbon layer is formed on the surface of the core. Non-limiting examples of the carbon precursor include coal pitch, mesophase pitch, petroleum pitch, coal oil, petroleum heavy oil, and polymer resin such as phenol resin, furan resin, and polyimide resin but the carbon precursor is not limited thereto. In particular, a vinyl-based resin such as polyvinylidene fluoride (PVDF), polyvinylchloride (PVC), and the like, a conductive polymer such as polyaniline (PAn), polyacetylene, polypyrrole, polythiophene, and the like may be used, and the conductive polymer may be doped with hydrochloric acid.

The prepared negative active material may have an average particle diameter of about 1 μm to about 20 μm. When the average particle diameter is in the above range, side reactions are suppressed and the diffusion rate in particles is maintained at a desirable level resulting in improvement of charge and discharge characteristics.

The binder improves binding properties of the negative active material particles to each other and to a current collector. The binder includes an organic-based binder, an aqueous binder, and combinations thereof. The organic-based binder refers to a binder that is dissolved or dispersed in an organic solvent, e.g., N-methylpyrrolidone (NMP), and an aqueous binder refers to a binder that uses water as a solvent or a dispersion medium.

When the organic-based binder is used as the binder, examples of the organic-based binder include polyvinylidene fluoride (PVDF), polyimide, polyamideimide, and a combination thereof, but are not limited thereto.

The binder may include an aqueous binder. Examples of the aqueous binder include a rubber-based binder such as a styrene-butadiene rubber, an acrylated styrene-butadiene rubber, an acrylonitrile-butadiene rubber, an acryl rubber, a butyl rubber, a fluorine rubber, and the like, polytetrafluoroethylene, polyethylene, polypropylene, an ethylenepropylene copolymer, polyethyleneoxide, polyvinylpyrrolidone, polyepichlorohydrin, polyphosphazene, polyacrylonitrile, polystyrene, an ethylene propylene diene copolymer, polyvinylpyridine, a chlorosulfonated polyethylene, latex, a polyester resin, an acryl resin, a phenol resin, an epoxy resin, polyvinyl alcohol, or combinations thereof, but are not limited thereto.

When an aqueous binder is used, a thickener may be further included. The thickener is a material that provides viscosity and ion conductivity to the aqueous binder. Examples of the thickener include carboxylmethyl cellulose (CMC), hydroxypropylmethyl cellulose and a combination thereof, but are not limited thereto.

The thickener may be included in a content ranging from about 0.1 parts by weight to about 10 parts by weight based on 100 parts by weight of the binder. When the thickener is included within the above range, it is possible to prevent a phenomenon whereby an electrode plate becomes hard while preventing sedimentation phenomenon at the same time.

The conductive material is used to give conductivity to an electrode, and any electroconductive materials that do not cause a chemical change may be used. Non-limiting examples of the conductive material include natural graphite, artificial graphite, and a mixture of conductive materials such as polyphenylene derivatives.

The negative electrode according to one embodiment may be fabricated by a method including mixing the negative active material, a binder, and selectively a conductive material in a solvent to prepare a negative active material composition, and applying the negative active material composition on a current collector to provide a negative active material layer.

The inorganic salt layer is described.

The inorganic salt layer includes an inorganic salt, a solvent, and selectively a binder.

The inorganic salt may be selected from the group consisting of a salt of alkaline cation and carbonate anion, a salt of alkaline cation and halogen anion, and combinations thereof. The inorganic salt may be selected from the group consisting of K₂CO₃, KCl, KF, Na₂CO₃, NaCl, NaF, or combinations thereof.

The content of the inorganic salt may range from about 0.1 parts by weight to about 10 parts by weight based on 100 parts by weight of the total weight of the active material. When the content of the inorganic salt falls in the above range, the battery capacity of the rechargeable lithium battery including the negative active material is not reduced.

The content of the inorganic salt may be somewhat different within the range according to the kind of the inorganic salt. For example, when the inorganic salt includes K as a cation, the content of the inorganic salt may range from about 5 parts by weight to about 10 parts by weight based on 100 parts by weight of the total weight of the active material, and when the inorganic salt includes Na as a cation, the content may range from about 1 part by weight to about 10 parts by weight based on 100 parts by weight of the total weight of the active material. The content of the inorganic salt may be controlled by those of ordinary skill in the art within the range according to the kind, concentration or coating conditions of inorganic salt coating liquid.

The inorganic salt may be dissolved in a solvent and can be coated on the surface of the negative active material composition layer. The solvent may be water, alcohol, acetone, tetrahydrofuran, or combinations thereof.

The concentration of the inorganic salt may range from about 5 wt % to about 20 wt %. Within the above concentration range, a solution with an appropriate coating concentration may be obtained. When the concentration is too low, a coating content is very low, while although the concentration is increased, a coating content does not increase any more.

A solution that includes an inorganic salt dissolved in the solvent may further include a binder. The binder includes polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyacrylic acid, polyethylene, a polypropylene styrene-butadiene rubber, an acrylated styrene-butadiene rubber, an epoxy resin, nylon, or combinations thereof, but is not limited thereto.

When the solution that includes an inorganic salt dissolved in the solvent may further include a binder in order to provide the inorganic salt layer, the binder may be different from a bonder of the negative active material composition layer. When the negative active material composition includes an organic-based binder, the binder of the inorganic salt layer is an aqueous binder, while when the negative active material composition includes an aqueous binder, the binder of the inorganic salt layer is an organic-based binder. When these binders are used in such a manner, the negative active material composition layer is prevented from being eluted again during a fabrication process of the inorganic salt layer on the surface of the negative active material composition layer.

According to another embodiment, a rechargeable lithium battery including the negative electrode, a positive electrode including a positive active material, and a non-aqueous electrolyte is provided.

The negative electrode is the same as the above negative electrode for a rechargeable lithium battery, and therefore, further description is not provided.

The positive electrode includes a current collector and a positive active material layer disposed on the current collector. The positive active material includes lithiated intercalation compounds that reversibly intercalate and deintercalate lithium ions. The positive active material may include a composite oxide including at least one selected from the group consisting of cobalt, manganese, and nickel, as well as lithium. In particular, the following lithium-containing compounds may be used:

LiₐA_{1-b}X_{b}D₂ (0.90≦a≦1.8, 0≦b≦0.5); LiₐE_{1-b}X_{b}O_{2-c}D_{c} (0.90≦a≦1.8, 0≦b≦0.5, 0≦c≦0.05); LiE_{2-b}X_{b}O_{4-c}D_{c} (0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); Li_{d}Ni_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); LiFePO₄.

In the above formulae, A is selected from the group consisting of Ni, Co, Mn, and combinations thereof; X is selected from the group consisting of Al, Ni, Co, Mn, Cr, Fe, Mg, Sr, V, a rare earth element, and combinations thereof; D is selected from the group consisting of O, F, S, P, and combinations thereof; E si selected from the group consisting of Co, Mn, and a combination thereof; T is selected from the group consisting of F, S, P, and combinations thereof; G is selected from the group consisting of Al, Cr, Mn, Fe, Mg, La, Ce, Sr, V, and combinations thereof; Q is selected from the group consisting of Ti, Mo, Mn, and combinations thereof; Z is selected from the group consisting of Cr, V, Fe, Sc, Y, and combinations thereof; and J is selected from the group consisting of V, Cr, Mn, Co, Ni, Cu, and combinations thereof.

The compound may have a coating layer on the surface, or the compound may be used after being mixed with another compound having a coating layer thereon. The coating layer may include at least one coating element compound selected from the group consisting of oxide and hydroxide of a coating element, oxyhydroxide of a coating element, oxycarbonate of a coating element, and hydroxycarbonate of a coating element, and combinations thereof. The compound that forms the coating layer may be amorphous or crystalline. The coating element included in the coating layer may be at least one selected from the group consisting of Mg, Al, Co, K, Na, Ca, Si, Ti, V, Sn, Ge, Ga, B, As, Zr, or mixtures thereof. The coating layer can be formed of the aforementioned compounds and elements in any forming method as long as it does not deteriorate the physical properties of the positive active material. Examples include spray coating and impregnation. Since these methods are known to those skilled in the art to which this disclosure pertains, they will not be described in further detail.

The positive active material layer also includes a binder and a conductive material.

The binder improves binding properties of the positive active material particles to one another, and also with a current collector. Examples of the binder include at least one selected from the group consisting of polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyacrylic acid, polyethylene, polypropylene, a styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material unless it causes a chemical change. Examples of the conductive material include one or more of carbon black, acetylene black, ketjen black, carbon fiber, a metal powder or a metal fiber including copper, nickel, aluminum, or silver, and polyphenylene derivatives.

The current collector may be Al, but is not limited thereto.

The positive electrode may be fabricated by a method including mixing the positive active material, a conductive material and a binder in a solvent to provide a positive active material composition and coating a current collector with the composition. The electrode manufacturing method is well known, and thus is not described in further detail. The solvent may be N-methylpyrrolidone, water, and the like, but it is not limited thereto.

In a rechargeable lithium battery according to one embodiment, a non-aqueous electrolyte includes a non-aqueous organic solvent and a lithium salt.

The non-aqueous organic solvent serves as a medium for transmitting ions taking part in the electrochemical reaction of the battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), fluoroethylene carbonate (FEC), propylene carbonate (PC), butylene carbonate (BC), and the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone, and the like. Examples of the alcohol-based solvent include ethyl alcohol, isopropyl alcohol, and the like, and examples of the aprotic solvent include nitriles such as R—CN (wherein R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio can be controlled in accordance with a desirable battery performance.

The carbonate-based solvent may include a mixture of a cyclic carbonate and a linear carbonate. The cyclic carbonate and the chain carbonate are mixed together in a volume ratio of about 1:1 to about 1:9, and when the mixture is used as an electrolyte, the electrolyte performance may be enhanced.

In addition, the non-aqueous organic electrolyte may further include mixtures of carbonate-based solvents and aromatic hydrocarbon-based solvents. The carbonate-based solvents and the aromatic hydrocarbon-based solvents may be mixed together in a volume ratio of about 1:1 to about 30:1.

The aromatic hydrocarbon-based organic solvent may be represented by the following Chemical Formula 1.

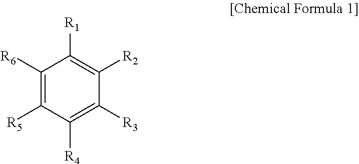

In the above Chemical Formula 1, R₁ to R₆ are independently hydrogen, a halogen, a C1 to C10 alkyl, a C1 to C10 haloalkyl, or a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-tri iodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or combinations thereof.

The non-aqueous electrolyte may further include vinylene carbonate or an ethylene carbonate-based compound of the following Chemical Formula 2.

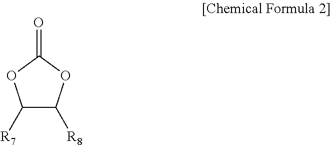

In the above Chemical Formula 2, R₇ and R₈ are independently hydrogen a halogen, a cyano (CN), a nitro (NO₂), a C1 to C5 fluoroalkyl, a unsaturated aromatic hydrocarbon group, or a unsaturated aliphatic hydrocarbon group, provided that at least one of R₇ and R₈ is a halogen, a nitro (NO₂), a C1 to C5 fluoroalkyl, and R₇ and R₈ are not simultaneously hydrogen.

The unsaturated aromatic hydrocarbon group includes a phenyl, a cyclo 1,3-pentadiene group, and the like, and the unsaturated aliphatic hydrocarbon group includes ethylene, propylene, butadiene, pentadiene, or hexatriene, and the like. The amount of the additive used for improving cycle life may be adjusted within an appropriate range.

The lithium salt supplies lithium ions in the battery, operates a basic operation of a rechargeable lithium battery, and improves lithium ion transport between positive and negative electrodes. Non-limiting examples of the lithium salt include at least one supporting salt selected from LiPF₆, LiBF₄, LiSbF₆, LiAsF₆, LiN (SO₂C₂F₅)₂, Li (CF₃SO₂)₂N, LiC₄F₉SO₃, LiClO₄, LiAlO₂, LiAlCl₄, LiN (CₓF₂ₓ₊₁SO₂, C_{y}F_{2y+1}SO₂ (where x and y are natural numbers), LiCl, LiI, and LiB(C₂O₄)₂ (lithium bisoxalato borate, LiBOB). The lithium salt may be used in a concentration ranging from about 0.1 M to about 2.0 M. When the lithium salt is included at the above concentration range, electrolyte performance and lithium ion mobility may be enhanced due to optimal electrolyte conductivity and viscosity.

The rechargeable lithium battery may further include a separator between a negative electrode and a positive electrode, as needed. Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

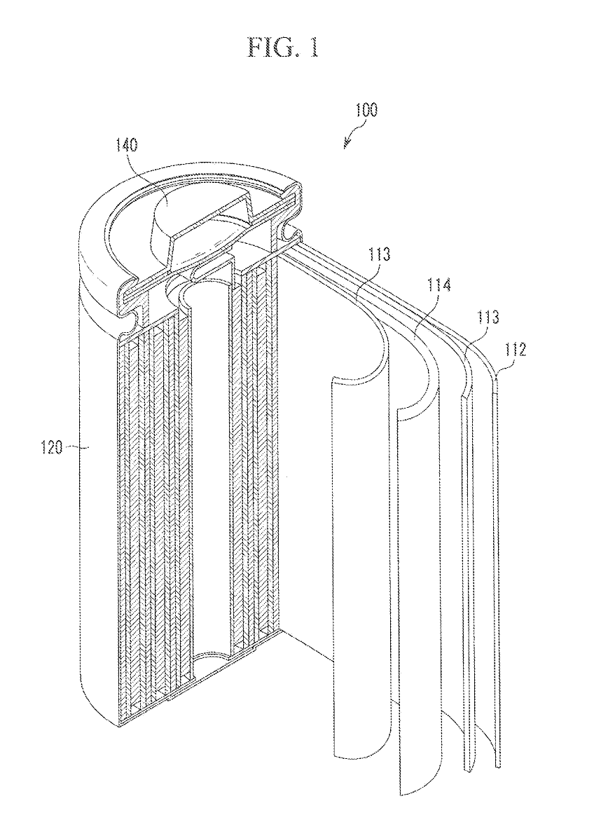

FIG. 1 is a schematic view of a representative structure of a rechargeable lithium battery. FIG. 1 illustrates a cylindrical rechargeable lithium battery 100, which includes a negative electrode 112, a positive electrode 114, a separator 113 interposed between the negative electrode 112 and the positive electrode 114, an electrolyte (not shown) impregnating the separator 113, a battery case 120, and a sealing member 140 sealing the battery case 120. The negative electrode 112, positive electrode 114, and separator 113 are sequentially stacked, spirally wound, and placed in a battery case 120 to fabricate such a rechargeable lithium battery 100.

The following examples illustrate this disclosure in more detail. These examples, however, are not in any sense to be interpreted as limiting the scope of this disclosure.

### Example 1

### 1) Fabrication of Negative Electrode

Si particles with a carbon layer are acquired by mixing Si particles with petroleum pitch, and performing a heat treatment in an atmosphere of nitrogen (N₂) at about 900° C. for about 6 hours. Through the heat treatment, the petroleum pitch is carbonized and the carbon layer including a hard carbon is formed on the surface of the Si particles. The thickness of the carbon layer is about 90 nm. The negative active material has an average particle diameter of about 5 μm. Also, the content of the Si particles of the negative active material is about 94 parts by weight based on 100 parts by weight of the active material, and the content of the amorphous carbon is about 5 parts by weight.

A negative active material composition is prepared by mixing the negative active material, and a polyamideimide binder at a 9:1 weight ratio in an N-methylpyrrolidone solvent. A negative electrode is fabricated through a typical electrode fabrication process in which a Cu-foil current collector is coated with the negative active material composition.

In order to provide an inorganic salt layer, 10 g of K₂CO₃ as an inorganic salt was added to 90 g of water, and the resultant is applied to the surface of the negative active material composition layer followed by vacuum-drying to provide a negative electrode.

### 2) Fabrication of Positive Electrode

A positive active material slurry is prepared by mixing LiCoO₂ positive active material, a polyvinylidene fluoride binder and a carbon black conductive material in N-methylpyrrolidone solvent. Herein, the mixing ratio of the positive active material, the binder and the conductive material is about 94:3:3. A positive electrode is fabricated through a typical electrode fabrication process in which an Al-foil current collector is coated with the positive active material slurry.

### 3) Fabrication of Rechargeable Lithium Battery Cell

A rechargeable lithium battery cell is fabricated through a typical process by using the positive electrode, the negative electrode and a non-aqueous electrolyte. As for the non-aqueous electrolyte, a mixed solvent (a volume ratio of about 3:7) of ethylene carbonate and ethylmethylcarbonate where 1.0M of LiPF₆ is dissolved is used.

### Example 2

A negative electrode is fabricated according to the same method as in Example 1 except for using KCl as an inorganic salt, instead of K₂CO₃.

A rechargeable lithium battery cell is fabricated according to the same method as in Example 1 by using the negative electrode.

### Example 3

A negative electrode is fabricated according to the same method as in Example 1 except for using KF as an inorganic salt, instead of K₂CO₃.

A rechargeable lithium battery cell is fabricated according to the same method as in Example 1 by using the negative electrode.

### Example 4

A negative electrode is fabricated according to the same method as in Example 1 except for using Na₂CO₃ as an inorganic salt, instead of K₂CO₃.

A rechargeable lithium battery cell is fabricated according to the same method as in Example 1 by using the negative electrode.

### Example 5

A negative electrode is fabricated according to the same method as in Example 1 except for using NaCl as an inorganic salt, instead of K₂CO₃.

A rechargeable lithium battery cell is fabricated according to the same method as in Example 1 by using the negative electrode.

### Example 6

A negative electrode is fabricated according to the same method as in Example 1 except for using NaF as an inorganic salt, instead of K₂CO₃.

A rechargeable lithium battery cell is fabricated according to the same method as in Example 1 by using the negative electrode.

### Comparative Example 1

A negative electrode is fabricated according to the same method as in Example 1, except that the negative active material composition layer is fabricated on a Cu-foil current collector using a typical electrode fabrication process. A rechargeable lithium battery cell is fabricated according to the same method as in Example 1 by using the negative electrode.

### Comparative Example 2

A negative electrode is fabricated according to the same method as in Example 1, except that the negative active material composition layer is fabricated on a Cu-foil current collector and then an inorganic salt layer including Li₂CO₃ as an inorganic salt instead of K₂CO₃ on the negative active material composition layer using a typical fabrication of an electrode. A rechargeable lithium battery cell is fabricated according to the same method as in Example 1 by using the negative electrode.

### Comparative Example 3

A negative electrode is fabricated according to the same method as in Comparative Example 2, except that LiF as an inorganic salt is used instead of Li₂CO₃.

A rechargeable lithium battery cell is fabricated according to the same method as in Example 1 by using the negative electrode.

The rechargeable lithium battery cells fabricated according to Examples 1 to 6 and Comparative Examples 1 to 3 are charged and discharged once with about 0.1 C, and their charge capacity, discharge capacity and initial efficiency are measured. The results are as shown in the following Table 1.

TABLE 1

| | | Charge | Discharge | |
|---|---|---|---|---|
| | Inorganic | capacity | capacity | Initial |
| | salt | (mAh/cc) | (mAh/cc) | efficiency |
| Comp. Ex. 1 | — | 1929.1 | 1351.5 | 70.1 |
| Comp. Ex. 2 | Li₂CO₃ | 1901.8 | 1348.7 | 70.9 |
| Comp. Ex. 3 | LiF | 1876.0 | 1320.3 | 70.4 |
| Ex. 1 | K₂CO₃ | 1840.3 | 1347.3 | 73.2 |
| Ex.2 | KCl | 1895.8 | 1384.9 | 73.1 |
| Ex.3 | KF | 1941.6 | 1379.4 | 71.0 |
| Ex.4 | Na₂CO₃ | 1851.3 | 1337.2 | 72.2 |
| Ex.5 | NaCl | 1912.1 | 1375.5 | 71.9 |
| Ex.6 | NaF | 1938.8 | 1377.0 | 71.0 |

As shown in Table 1, the rechargeable lithium battery cells according to Examples 1 to 6 show remarkably improved initial efficiency compared to those of Comparative Examples 1 to 3. Comparing the results of Examples 1 to 6 and Comparative Examples 2 and 3, when the inorganic salt layers including a K cation or a Na cation are disposed on a negative active material composition layer, initial efficiency is much improved over when the inorganic salt layer includes a Li cation.

The exothermic heats and exothermic peak temperatures of the negative active materials of the rechargeable lithium battery cells fabricated according to Examples 1 to 6 and Comparative Examples 1 to 3 which are obtained by disassembling electrode plates in a charged state are measured by using differential scanning calorimetry (DSC), and a DSC ascending temperature curve is drawn by raising the temperature from about 50° C. to about 400° C. in an atmosphere of nitrogen gas (30 ml/min) at a temperature heating rate of about 10° C./min. The results are as shown in Table 2. The differential scanning calorimetry (DSC) is Q2000 differential scanning calorimetry produced by TA Instrument company. The measurement instrument is pressure cell with gold seal sealing.

TABLE 2

| | Inorganic | Exothermic |
|---|---|---|
| | salt | heat (%) |
| Comp. Ex. 1 | — | 100 |
| Comp. Ex. 2 | Li₂CO₃ | 85 |
| Comp. Ex. 3 | LiF | 60 |
| Ex. 1 | K₂CO₃ | 5 |
| Ex. 2 | KCl | 5 |
| Ex. 3 | KF | 25 |
| Ex. 4 | Na₂CO₃ | 5 |
| Ex. 5 | NaCl | 55 |
| Ex. 6 | NaF | 35 |

As shown in Table 2, the negative active materials obtained from the negative electrodes of the rechargeable lithium battery cells according to Examples 1 to 6 are more stable at a higher temperature compared with those obtained from the rechargeable lithium battery cells according to Comparative Examples 1 to 3.

Referring to Table 2, the negative electrodes obtained from the rechargeable lithium battery cells according to Examples 1 to 6 show exothermic peak temperatures of about 350° C. or more. Also, the exothermic heats of Table 2 are relative values determined when it is assumed that the exothermic heat of Comparative Example 1 is 100. It may be seen from Table 2 that the exothermic heats of Examples 1 to 6 are reduced, compared to that of the Comparative Example 1.

The capacity retention (i.e., cycle life) of the rechargeable lithium battery cells fabricated according to Examples 1 to 6 and Comparative Examples 1 to 3 are measured. The results are as shown in the following Table 3. The capacity retention (i.e., cycle life characteristics) are measured by performing a charge and discharge at about 25° C. with about 1.0 C about 50 times. The measurement result is shown as a ratio of a discharge capacity at the 50^{th} cycle to a discharge capacity at the first cycle.

TABLE 3

| | Inorganic | Capacity |
|---|---|---|
| | salt | retention (%) |
| Comp. Ex. 1 | — | 67 |
| Comp. Ex. 2 | Li₂CO₃ | 65 |
| Comp. Ex. 3 | LiF | 60 |
| Ex. 1 | K₂CO₃ | 73 |
| Ex. 2 | KCl | 81 |
| Ex. 3 | KF | 80 |
| Ex. 4 | Na₂CO₃ | 70 |
| Ex. 5 | NaCl | 71 |
| Ex. 6 | NaF | 73 |

Referring to Table 3, the capacity retention of the rechargeable lithium battery cells fabricated according to Examples 1 to 6 at the 50^{th} cycle are higher than the capacity retention of the rechargeable lithium battery cell fabricated according to Comparative Example 1 at the 50^{th} cycle. Therefore, it may be seen that the rechargeable lithium battery cells including the negative active material prepared according to an embodiment of this disclosure have improved cycle life characteristics.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative electrode for a rechargeable lithium battery comprising:
a current collector,
a negative active material composition layer disposed on the surface of the current collector including a negative active material; and
an inorganic salt layer disposed on the surface of the negative active material composition layer including an inorganic salt,
wherein the negative active material comprises a core including silicon and a carbon layer disposed on the surface of the core,
and the inorganic salt comprises an alkaline metal cation selected from a Na cation, a K cation, or a combination thereof; and an anion selected from a carbonate anion, a halogen anion, or a combination thereof.

2. The negative electrode of claim 1, wherein the core comprises Si, SiOₓ (0<x<2), a Si—Z alloy, or a combination thereof, where Z is an element selected from the group consisting of an alkaline metal, an alkaline-earth metal, a group 13 element, a group 14 element, a transition element, a rare earth element, and a combination thereof, but is not Si.

3. The negative electrode of claim 1, wherein the carbon layer comprises an amorphous carbon.

4. The negative electrode of claim 1, wherein the carbon layer comprises an amorphous carbon selected from the group consisting of soft carbon, hard carbon, mesophase pitch carbide, fired coke, and mixtures thereof.

5. The negative electrode of claim 1, wherein the content of the carbon layer ranges from about 1 part by weight to about 20 parts by weight based on 100 parts by weight of the negative active material.

6. The negative electrode of claim 1, wherein the thickness of the carbon layer ranges from about 1 nm to about 100 nm.

7. The negative electrode of claim 1, wherein the negative active material has an average particle diameter of about 1 μm to about 20 μm.

8. The negative electrode of claim 1, wherein the inorganic salt comprises K₂CO₃, KCl, KF, Na₂CO₃, NaCl, NaF, or combinations thereof.

9. The negative electrode of claim 1, wherein the content of the inorganic salt ranges from about 0.1 part by weight to about 10 parts by weight based on 100 parts by weight of the total weight of the negative active material.

10. A rechargeable lithium battery comprising:
a negative electrode comprising
a current collector,
a negative active material composition layer disposed on the surface of the current collector including a negative active material, and
an inorganic salt layer disposed on the surface of the negative active material composition layer including an inorganic salt;
a positive electrode including a positive active material; and
a non-aqueous electrolyte,
wherein the negative active material comprises a core including silicon and a carbon layer disposed on the surface of the core.
and the inorganic salt comprises an alkaline metal cation selected from a Na cation, a K cation, or a combination thereof; and an anion selected from a carbonate anion, a halogen anion, or a combination thereof.

11. The rechargeable lithium battery of claim 10, wherein the core comprises Si, SiOₓ (0<x<2), a Si—Z alloy or a combination thereof where Z is an element selected from the group consisting of an alkaline metal, an alkaline-earth metal, a group 13 element, a group 14 element, a transition element, a rare earth element, and a combination thereof, but is not Si.

12. The rechargeable lithium battery of claim 10, wherein the carbon layer comprises an amorphous carbon.

13. The rechargeable lithium battery of claim 10, wherein the carbon layer comprises an amorphous carbon selected from the group consisting of soft carbon, hard carbon, mesophase pitch carbide, fired coke, and a mixture thereof.

14. The rechargeable lithium battery of claim 10, wherein the content of the carbon layer ranges from about 1 part by weight to about 20 parts by weight based on 100 parts by weight of the negative active material.

15. The rechargeable lithium battery of claim 10, wherein the thickness of the carbon layer ranges from about 1 nm to about 100 nm.

16. The rechargeable lithium battery of claim 10, wherein the negative active material has an average particle diameter of about 1 μm to about 20 μm.

17. The rechargeable lithium battery of claim 10, wherein the inorganic salt comprises K₂CO₃, KCl, KF, Na₂CO₃, NaCl, NaF, or a combination thereof.

18. The rechargeable lithium battery of claim 10, wherein the content of the inorganic salt ranges from about 0.1 part by weight to about 10 parts by weight based on 100 parts by weight of the total weight of the negative active material.
